(19) United States
(12) Patent Application Publication
(10) Pub. No.: US 2001/0051326 A1
(43) Pub. Date: Dec. 13, 2001

(54) Religious informational cards

(76) Inventor: Michael Sahlein, San Francisco, CA (US)

Correspondence Address: Matthew J. Peirce, Esq., 1550 Starlight Canyon Avenue, Las Vegas, NV, 89123, US

(21) Appl. No.: 09/878,064

(22) Filed: Jun. 7, 2001

Related U.S. Application Data
(60) Provisional application No. 60/210,025, filed on Jun. 8, 2000.

(51) Int. Cl. G09B 19/22

(52) U.S. Cl. 434/129

(57) ABSTRACT

A new and improved set of informational cards that will allow individuals to learn more about people mentioned in the Bible in a positive and enlightened manner is disclosed. Each of the informational cards would be exactly the size of a standard baseball card. Each of the informational cards would have a front face and a rear face, with the front face of each card having a picture of a particular person mentioned in the Bible. The rear face of each card would provide various notes, comments, quotes, and thoughts relevant to the particular person who would be displayed on the front face of that particular card. A package of multiple cards could be bought by an interested user in a manner analogous to the manner in which a person would buy a pack of baseball cards.

### I. BACKGROUND OF THE INVENTION

The present invention concerns that of a new and improved set of informational cards that will allow individuals to learn more about people mentioned in the Bible in a positive and enlightened manner.

### II. DESCRIPTION OF THE PRIOR ART

U.S. Pat. No. 5,224,862, issued to Sullivan, discloses a religious learning unit for initial teaching and reinforcement teaching of biblical knowledge and principles in a competitive, but supportive game environment.

U.S. Pat. No. 5,152,535, issued to Roberts, discloses a Bible quiz game including a game board divided into four equal playing sections.

U.S. Pat. No. 595,440, issued to James, discloses a biblical game apparatus adapted to be employed in play by two or more persons and involving the use of a plurality of cards or counters which are related to each other in groups to form books designated by and having reference to the construction and characteristics of the City of the New Jerusalem.

U.S. Pat. No. 155,778, issued to West, discloses a series of cards for social games, illustrated with portraits of distinguished or noted persons, said portrait cards being arranged in books or groups of cards, which are classed, numbered or designated according to the title, profession, or occupation of the persons whose portraits are borne upon the cards of the respective groups.

### III. SUMMARY OF THE INVENTION

The present invention concerns that of a new and improved set of informational cards that will allow individuals to learn more about people mentioned in the Bible in a positive and enlightened manner. Each of the informational cards would be exactly the size of a standard baseball card. Each of the informational cards would have a front face and a rear face, with the front face of each card having a picture of a particular person mentioned in the Bible. The rear face of each card would provide various notes, comments, quotes, and thoughts relevant to the particular person who would be displayed on the front face of that particular card. A package of multiple cards could be bought by an interested user in a manner analagous to the manner in which a person would buy a pack of baseball cards.

There has thus been outlined, rather broadly, the more important features of an improved set of informational cards in order that the detailed description thereof that follows may be better understood and in order that the present contribution to the art may be better appreciated. There are, of course, additional features of the improved set of informational cards that will be described hereinafter and which will form the subject matter of the claims appended hereto.

In this respect, before explaining at least one embodiment of the improved set of informational cards in detail, it is to be understood that the improved set of informational cards is not limited in its application to the details of construction and to the arrangements of the components set forth in the following description or illustrated in the drawings. The improved set of informational cards is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present improved set of informational cards. It is important, therefore, that the claims be regarded as including such equivalent constructions insofar as they do not depart from the spirit and scope of the present invention.

It is therefore an object of the present invention to provide an improved set of informational cards, which has all of the advantages of the prior art and none of the disadvantages.

It is another object of the present invention to provide an improved set of informational cards which may be easily and efficiently manufactured and marketed.

It is another object of the present invention to provide an improved set of informational cards which is of durable and reliable construction.

It is yet another object of the present invention to provide an improved set of informational cards which is economically affordable and available for relevant purchasing government entities.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a front view of the front face of a representative card of the present invention.

FIG. 2 shows a front view of the rear face of a representative card of the present invention.

### V. DESCRIPTION OF THE PREFERRED EMBODIMENT

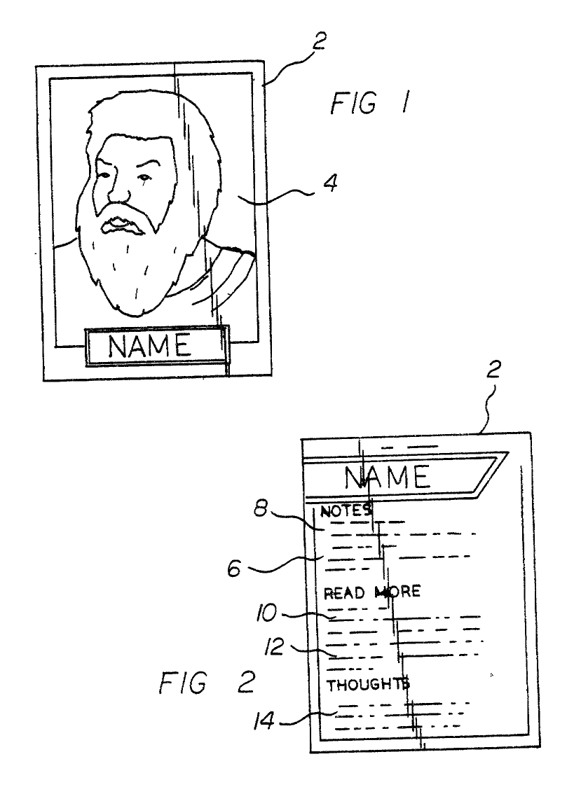

FIG. 1 shows a front view of the front face of a representative informational card 2 of the present invention. The present invention would comprise a set 3 of informational cards which would depict people mentioned in the Bible. Each of the informational cards would be exactly the size of a standard baseball card. Each of the informational cards would have a front face 4 and a rear face 6, with the front face 4 of each card having a picture of a particular person mentioned in the Bible. Front face 4 of representative informational card 2 has a picture of St. Matthew, who is a prominent figure in the New Testament.

FIG. 2 shows a front view of rear face 6 of representative informational card 2 of the present invention. Rear face 6 of each informational card 2 would provide various notes 8, comments 10, quotes 12, and thoughts 14 relevant to the particular person who would be displayed on front face 4 of a particular informational card 2. In FIG. 2, various notes 8, quotes 12, and thoughts 14 relevant to St. Matthew are shown.

A package 16 of multiple cards could be bought by an interested user in a manner analogous to the manner in which a person would buy a pack of baseball cards. Each package 16 would preferably include five or ten informational cards 2 of the present invention, but each package 16 could include any specific number of informational cards 2, depending on the decision of the manufacturer and/or printer of the present invention.

The cards could be marketed in various ways. First, one copy of each informational card 2 would constitute a set 18, which could also be sold by a retailer/manufacturer. Each set 18 would include one copy of each informational card 2 that would be available with a particular printing, and would be an exceptionally good marketing tool as a gift or collectible for individuals interested in Christianity.

Each set 18 would also come with an informational card 2 which would be a checklist 20, The checklist 20 would have a list of each individual information card 2 in the entire set I 8. A user could use checklist 20 to check off each individual information card 2 in that particular user's possession, while also allowing that particular user to have knowledge as to the particular informational cards 2 that they would need to complete their set 18.

Each set 18 would preferably have an individual informational card 2 for each Book in the Bible, including both the Old Testament and the New Testament. Alternatively, each set 18 could have individual informational cards 2 for each individual mentioned in the Bible, with particular notes 8, comments 10, quotes 12, and thoughts 14 relevant to that person associated with each particular card.

In addition, the informational cards 2 of the present invention could also be designed to include geographical locations, such as the sea of Galilee, Horeb, and Bethlehem. Furthermore, other cities, mountains, seas, water and land formations along with countries could be included. The front face 4 of each informational card 2 could include a picture of the geographical location along with its name and the rear face 6 of each card would provide a description of the geographical location along with various notes, comments, quotes, and thoughts relevant to the geographical location.

What I claim as my invention is:

1. A first informational card having a front face and a rear face, the front face of the first informational card having a pictorial representation of a person mentioned in the Bible, the rear face of the first informational card including biblical and religious information with regard to the person depicted on the front face of the informational card.

2. A first informational card according to claim I in which the first informational card would be exactly the size of a standard baseball card.

3. A first informational card according to claim 2 in combination with:
(a) at least one additional informational card, the additional informational card having a front face and a rear face, the front face of the additional informational card having a pictorial representation of a person mentioned in the Bible, the rear face of the additional informational card including biblical and religious information with regard to the person depicted on the front face of the informational card, the pictorial representation of the person on the additional informational card and all subsequent additional informational cards being different than that of the person depicted on the informational card and other additional informational cards, if any, and
(b) a checklist card, the checklist card including a list of each person depicted on both the informational card and all additional informational cards,
(c) whereby the first informational cards, all additional informational cards, and the checklist will comprise a set of informational cards.

4. The first informational card and the additional informational cards according to claim 3 wherein the people depicted on the first informational card and the additional informational cards would be authors of separate books in the Bible.

5. The first informational card and the additional informational cards according to claim 3 wherein the people depicted on the first informational card and the additional informational cards would be people mentioned in the Bible.

6. The set of informational cards according to claim 3 wherein the set would further comprise at least one geographical card, each geographical card having a front face and a rear face, the front face of each geographical card having a pictorial representation of a geographical location mentioned in the Bible, the rear face of the first informational card including biblical and religious information with regard to the geographical location depicted on the front face of the geographical card.
